(19) United States
(12) Patent Application Publication
(10) Pub. No.: US 2007/0170155 A1
(43) Pub. Date: Jul. 26, 2007

(54) Method and apparatus for modifying an etch profile

(76) Inventor: Steven T. Fink, Mesa, AZ (US)

Correspondence Address: DLA PIPER US LLP, P. O. BOX 9271, RESTON, VA, 20195, US

(21) Appl. No.: 11/335,683

(22) Filed: Jan. 20, 2006

(51) Int. Cl. B23K 9/00

(52) U.S. Cl. 219/121.43

(57) ABSTRACT

A plasma reactor includes a plasma processing chamber which can, for example, play the role of a vacuum chamber and an electrode disposed inside the plasma processing chamber. The plasma reactor further includes a plasma control structure imbedded entirely within the electrode. The plasma control structure is configured and arranged to alter characteristics of a plasma generated inside the processing chamber.

### FIELD OF THE INVENTION

The present invention relates generally to plasma, and relates specifically to a method and apparatus for controlling plasma process characteristics.

### BRIEF SUMMARY OF THE INVENTION

An aspect of the present invention is to provide a plasma reactor, including a plasma processing chamber which can, for example, play the role of a vacuum chamber and an electrode disposed inside the plasma processing chamber. The plasma reactor further includes a plasma control structure imbedded entirely within the electrode. The plasma control structure is configured and arranged to alter characteristics of a plasma generated inside the processing chamber.

### BRIEF DESCRIPTION OF THE DRAWINGS

FIG. 1 is a schematic representation of a plasma reactor comprising a plasma control structure, according to an embodiment of the present invention;

FIG. 2 is a schematic representation of a plasma reactor comprising a plasma control structure, according to another embodiment of the present invention;

FIG. 3 is a schematic representation of a plasma reactor comprising a plasma control structure, according to yet another embodiment of the present invention;

FIG. 4 is a cross-sectional view of a substrate holder and an electrode assembly of the plasma reactors depicted in FIGS. 1-3, including the plasma control structure, according to an embodiment of the present invention;

FIGS. 5A and 5B are cross-sectional views of a substrate holder and an electrode assembly of plasma reactors depicted in FIGS. 1-3, showing the placement of the plasma control structure, according to various embodiments of the present invention;

FIGS. 6A, 6B and 6C are cross-sectional views of a substrate holder and an electrode assembly of plasma reactors depicted in FIGS. 1-3, showing the placement of the plasma control structure, according to further embodiments of the present invention;

FIG. 7 is a cross-sectional view of a substrate holder and an electrode assembly of plasma reactors depicted in FIGS. 1-3, showing the plasma control structure, according to another embodiment of the present invention;

FIG. 8 is a transverse view of an electrode assembly and a chuck assembly showing a configuration of the plasma control structure in the plasma reactor depicted in FIG. 1, according to an embodiment of the present invention;

FIG. 9 is transverse view of an electrode assembly and a chuck assembly showing another configuration of the plasma control structure in the plasma reactor depicted in FIG. 1, according to another embodiment of the present invention; and

FIG. 10 is flow chart showing a method of controlling a plasma, according to an embodiment of the present invention.

### DESCRIPTION OF EMBODIMENTS OF THE INVENTION

Plasma processing systems are used in the manufacture and processing of semiconductors, integrated circuits, displays and other devices and materials, to remove material from or to deposit material on a substrate such as a semiconductor substrate. In some instances, these plasma processing systems use electrodes for providing RF energy to a plasma useful for depositing on or removing material from a substrate.

There are several different kinds of plasma processes used during substrate processing. These processes include, for example: plasma etching, plasma deposition, plasma assisted photoresist stripping and in-situ plasma chamber cleaning.

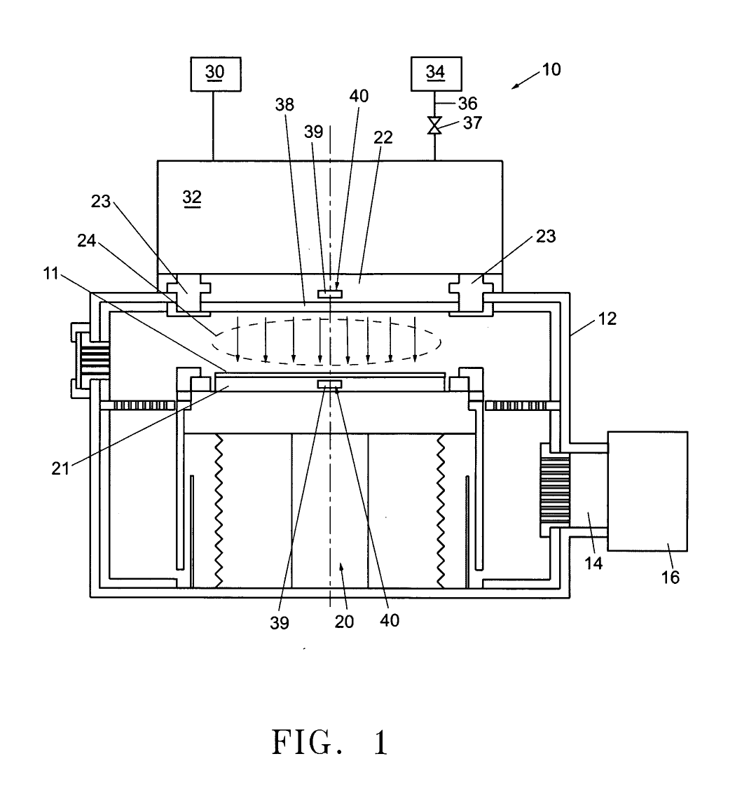

FIG. 1 shows a plasma reactor according to an embodiment of the present invention. The plasma reactor 10 includes a plasma processing chamber 12 that can function, for example, as a vacuum processing chamber adapted to perform plasma etching from and/or material deposition on a substrate 11. However, it must be appreciated that the plasma chamber 12 may be used in a configuration other than as a vacuum chamber, for example as an atmospheric chamber at atmospheric pressure. The substrate 11 can be, for example, a semiconductor substrate such as a silicon wafer. However, other types of substrates are also within the scope of the present invention. The chamber 12 is provided with an exhaust port 14 for connecting a vacuum pump 16. Vacuum pump 16 can be, for example, a turbo-molecular pump (TMP) configured to evacuate excess process gases from the chamber 12.

The plasma reactor 10 also includes a chuck assembly 20 and an electrode assembly 22. The chuck assembly 20 supports the substrate 11 while it is processed in the chamber 12. The chuck assembly 20 includes a substrate holder 21 constructed and arranged to hold the substrate 11 during processing. In this embodiment, the electrode assembly 22 is capacitively coupled to the plasma when the substrate is being plasma processed, i.e. a capacitively coupled plasma (CCP) source assembly is used in the plasma reactor 10. Plasma is formed in an interior region 24. The plasma may have a plasma density (i.e., number of ions/volume, along with energy/ion) that is uniform, unless the density needs to be tailored to account for other sources of process non-uniformities or to achieve a desired process non-uniformity. In order to protect the electrode assembly 22 and other components from heat damage due to the plasma, a cooling system in fluid communication with the electrode assembly 22 may be included for flowing a cooling fluid to and from the electrode assembly 22.

The electrode assembly 22 may be electrically connected to an RF power supply system 30 via an electrode impedance match network 32. The impedance match network 32 matches the impedance of RF power supply system 30 to the impedance of the electrode assembly 22 and the associated excited plasma. In this way, the power may be delivered by the RF power supply to the plasma electrode assembly 22 and the associated excited plasma with reduced reflection. The plasma electrode assembly 22 is electrically insulated from the walls of the process chamber 12 by insulators 23.

In addition, the chuck assembly 20 used to support or hold the substrate (e.g. wafer) 11, can also be provided with an RF power supply or a DC power supply (not shown) coupled thereto to bias the substrate. In this case, the chuck assembly 20 is associated with an electrode or an electrode is associated with the chuck. Similarly to the electrode assembly 22, the RF bias can be applied to substrate chuck electrode assembly 20 (or substrate holder 21) through an impedance match network (not shown).

The plasma reactor 10 further includes a gas supply system 34 in communication with the plasma chamber 12 via one or more gas conduits 36 for supplying gas, in a regulated manner using a regulator 37, through a gas injection plate 38 to form the plasma. In this embodiment, the gas injection plate 38 is attached to the electrode assembly 22. The gas supply system 36 can supply one or more gases such as chlorine, hydrogen-bromide, octafluorocyclobutane, or various other fluorocarbon compounds, or for chemical vapor deposition applications can supply one or more gases such as silane, tungsten-tetrachloride, titanium-tetrachloride, or the like.

The plasma reactor 10 further includes a plasma control structure 40. The plasma control structure 40 is configured to affect a uniformity of a plasma process in the vicinity of the substrate 11 in interior region 24. The plasma control structure 40 comprises a slug member and/or ring member 39 disposed within the electrode assembly 22, within the chuck assembly 20, or both. For example, as shown in FIG. 1, the slug member and/or ring member 39 of the plasma control structure 40 is disposed both inside, i.e., imbedded entirely within, the electrode assembly 22 and the substrate holder 21 of the chuck assembly/electrode 20. Therefore, the plasma control structure 40 is not exposed directly the plasma generated in plasma region 24. That is, the plasma control structure is not impinged by species, including ionic species, radicals, electrons and photons, generated in the plasma.

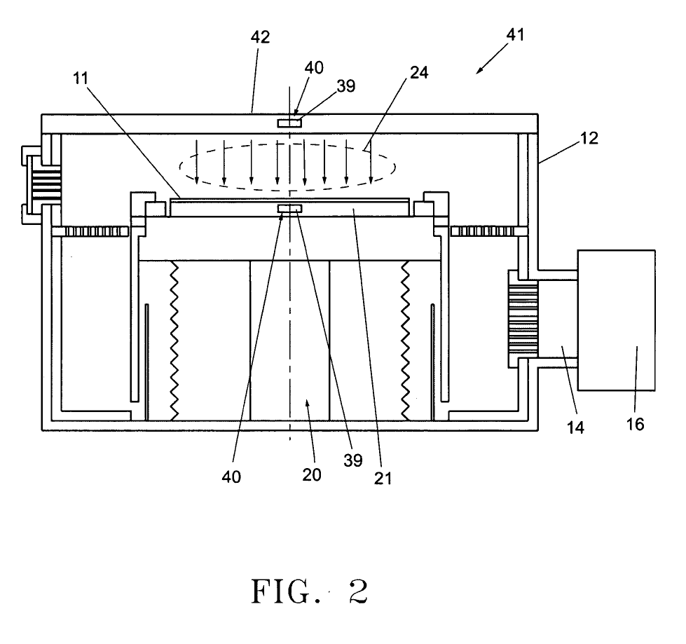

FIG. 2 shows another embodiment of a plasma reactor according to the present invention. In this embodiment, the plasma reactor 41 is similar to the plasma reactor 10 shown in FIG. 1. However, in the present embodiment, the electrode assembly 42 in plasma reactor 41 is connected to the ground (substantially zero volt) instead of being electrically connected to an RF power supply. Hence, in this case, the plasma in plasma region 24 is generated using an RF power supply connected to the chuck assembly 20 via an associated impedance match network (not shown). In this way, the power may be delivered by the RF power supply to the chuck assembly 20 and the associated excited plasma with reduced reflection. In this case, the chuck assembly 20 is associated with an electrode for delivering the RF power to excite the plasma, and the chuck assembly 20 is utilized as a substrate holder for substrate 11. Similar to the plasma reactor 10 depicted in FIG. 1, the plasma reactor 41 also comprises a plasma control structure 40. The plasma control structure 40 comprises a slug member and/or ring member 39 disposed within (e.g., imbedded entirely within) the electrode assembly 42, disposed within the chuck assembly/electrode 21, or both.

For example, as shown in FIG. 1, the slug member and/or ring member 39 of the plasma control structure 40 is disposed both inside, i.e., imbedded entirely within, the electrode assembly 22 and the substrate holder 21 of the chuck assembly/electrode 20. Therefore, the plasma control structure 40 is not exposed directly the plasma generated in plasma region 24. That is, the plasma control structure is not impinged by species, including ionic species, radicals, electrons and photons, generated in the plasma.

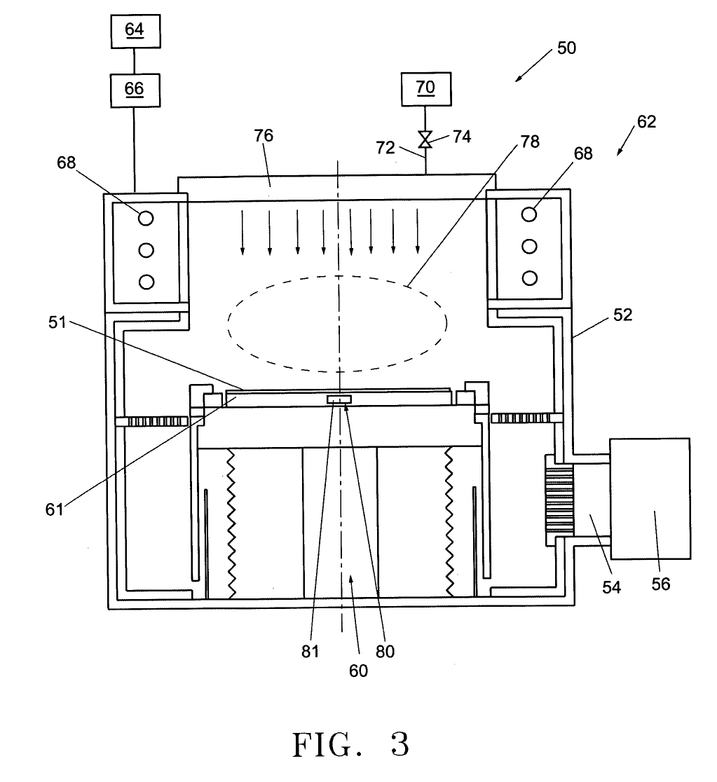

FIG. 3 shows another embodiment of a plasma reactor according to the present invention. Similarly to plasma reactor 10 depicted in FIG. 1, the plasma reactor 50 includes a plasma chamber 52 that functions as a vacuum processing chamber adapted to perform plasma etching from and/or material deposition on a substrate 51. However, it must be appreciated that the plasma chamber 52 may be used in a configuration other than as a vacuum chamber, for example as an atmospheric chamber at atmospheric pressure. The substrate 51 can be, for example, a semiconductor substrate such as a silicon wafer. However, other types of substrates are also within the scope of the present invention. In this embodiment, the chamber 52 is provided with an exhaust port 54 for connecting a vacuum pump 56. Vacuum pump 56 can be, for example, a turbo-molecular pump (TMP) configured to evacuate excess process gases from the chamber 52.

The plasma reactor 50 also includes a chuck assembly 60. The chuck assembly 60 supports the substrate 51 while it is processed in the chamber 52. The chuck assembly 60 includes a substrate holder 61 configured and arranged to hold the substrate 51 during processing.

The plasma reactor 50 further includes an electrostatic radio frequency (ESRF) plasma source 62. The ESRF 62 comprises an RF power supply system 64, an impedance match network 66 and an induction coil 68. The induction coil 68 is wound around the chamber 52. The impedance match network 66 matches the impedance of RF power supply system 64 to the impedance of the induction coil 68 and the associated excited plasma so as to deliver the power of the RF power supply to the associated excited plasma with reduced reflection.

Similar to the plasma reactor 10, the plasma reactor 50 also includes a gas supply system 70 in communication with the plasma chamber 52 via one or more gas conduits 72 for supplying gas, in a regulated manner using a regulator 74, through a gas injection plate 76 to form the plasma in interior region 78 of chamber 52. In this embodiment, the gas injection plate 76 is attached to a wall of chamber 52 (for example, the upper wall). The gas supply system 70 can supply one or more gases such as chlorine, hydrogen-bromide, octafluorocyclobutane, or various other fluorocarbon compounds, or for chemical vapor deposition applications can supply one or more gases such as silane, tungsten-tetrachloride, titanium-tetrachloride, or the like.

Similarly to the embodiment shown in FIG. 1, the plasma reactor 50 further includes a plasma control structure 80. The plasma control structure 80 is configured to affect a uniformity of a plasma process in the vicinity of the substrate 51 in interior region 78. The plasma control structure 80 comprises a slug member and/or a ring member 81 disposed within the chuck assembly 20, for example imbedded entirely within substrate holder 61. Hence, similarly to the embodiment shown in FIGS. 1 and 2, the plasma control structure 80 is not exposed directly to the plasma.

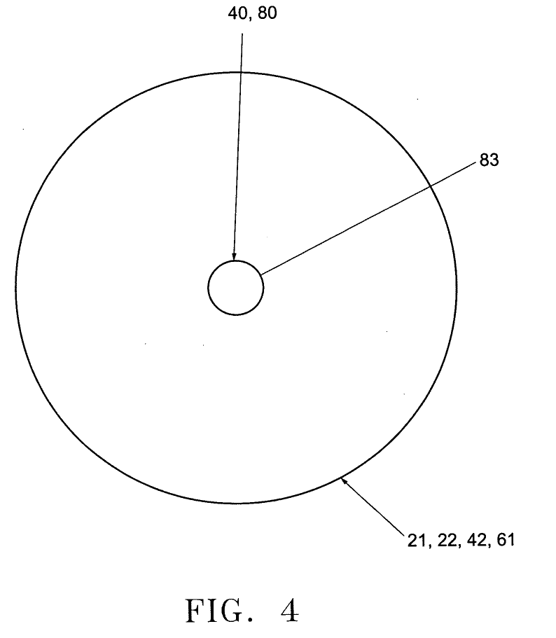

FIG. 4 is a cross-sectional view of substrate holder 21 and electrode assembly 22 of plasma reactor 10, electrode assembly 42 of plasma reactor 41 and substrate holder 61 of plasma reactor 50 showing the placement of the plasma control structure 40, 80, according to an embodiment of the invention. In this embodiment, the plasma control structure 40, 80 comprises a single slug 83 inserted in or otherwise imbedded within a body of the substrate holder 21, the electrode assembly 22, or both, in plasma reactor 10, inserted in, or otherwise imbedded within, a body of the electrode assembly 42, in plasma reactor 41, or inserted in, or otherwise embedded within, a body of substrate holder 61 in plasma reactor 50. For example, the slug 83 may be positioned substantially at a center of the substrate holder 21, the electrode assembly 22, the electrode assembly 42, or substrate holder 61. As shown in FIG. 4, the slug 83 is a disk-shaped object, i.e. with a circular cross-section. However, it must be appreciated that the slug 83 may have any other cross-sectional shape including a polygonal cross-section, an elliptical cross-section or a combination thereof. The slug 83 may also have a spherical shape, an ellipsoid shape or a more complex shape. The shape of the slug 83 in the electrode assembly 22, 42 and/or substrate holder/electrode 21, 61 can be selected to achieve desired plasma process characteristics. For example, the shape of the slug 83 can be selected to achieve a certain etch or deposition uniformity.

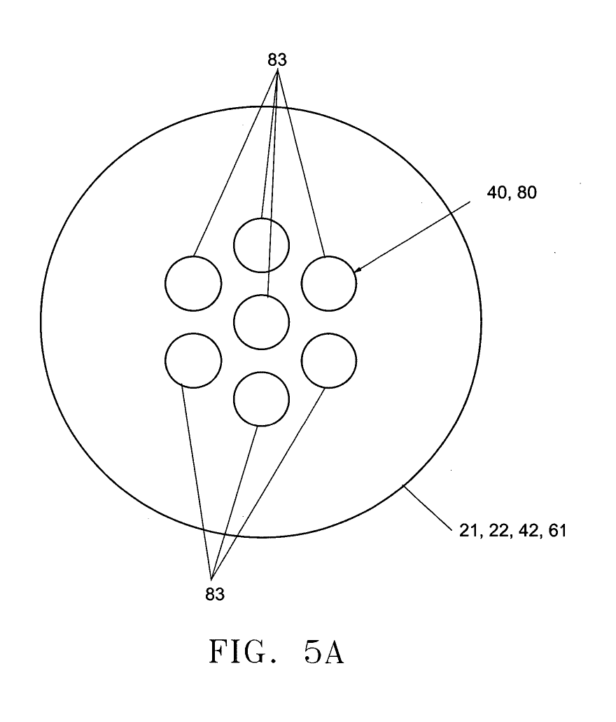

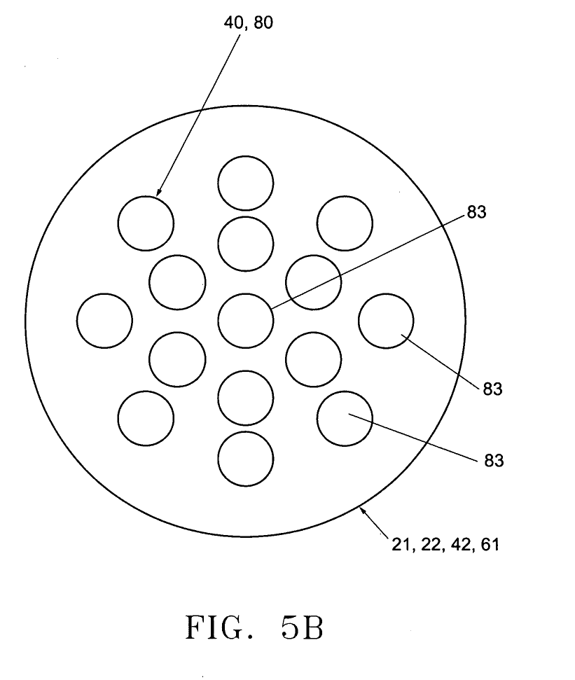

FIGS. 5A and 5B are cross-sectional views of substrate holder 21 and electrode assembly 22 of plasma reactor 10, electrode assembly 42 of plasma reactor 41 and substrate holder 61 of plasma reactor 50 showing the placement of the plasma control structure 40, 80, according to various embodiments of the invention. The plasma control structure 40, 80 comprises a plurality of slugs 83 (7 slugs in the embodiment shown in FIG. 5A and 15 slugs in the embodiment shown in FIG. 5B) inserted or imbedded in a body of the substrate holder 21, the electrode assembly 22, or both in the plasma reactor 10, inserted or imbedded in a body of the electrode assembly 42 in plasma reactor 41 or inserted or imbedded in a body of substrate holder 61 of plasma reactor 50. As shown in FIGS. 5A and 5B, the plurality of slugs 83 in the plasma control structure 40, 80 have a disk shape, i.e., with a circular cross-section. However, it must be appreciated that any of the plurality of slugs may have any cross-sectional shape, including polygonal and elliptical and may have a spherical, ellipsoid or a more complex shape. In addition, the plurality of slugs 83 in the plasma control structure 40, 80 may be provided with the same dimensions or with different dimensions to control the plasma as desired.

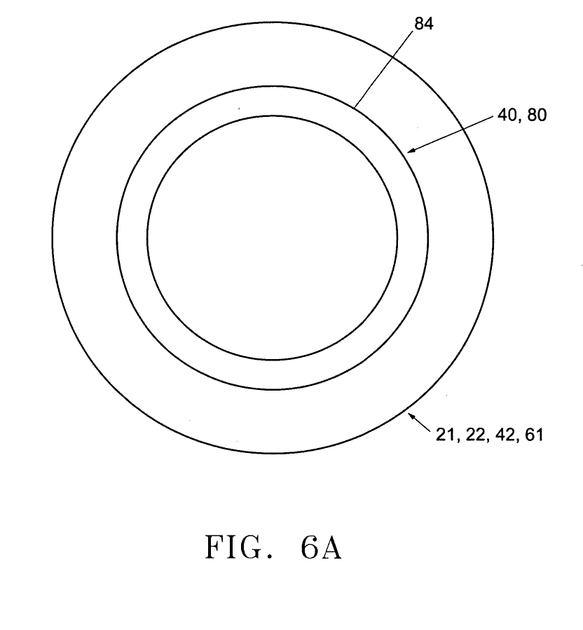

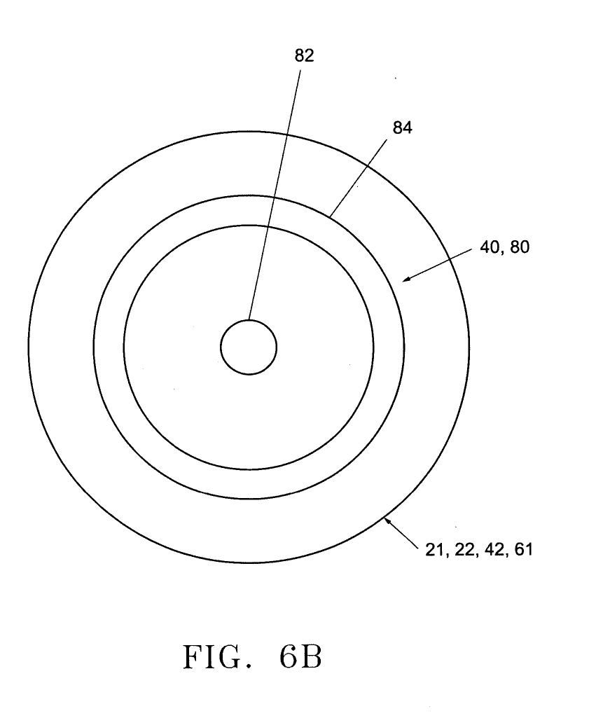

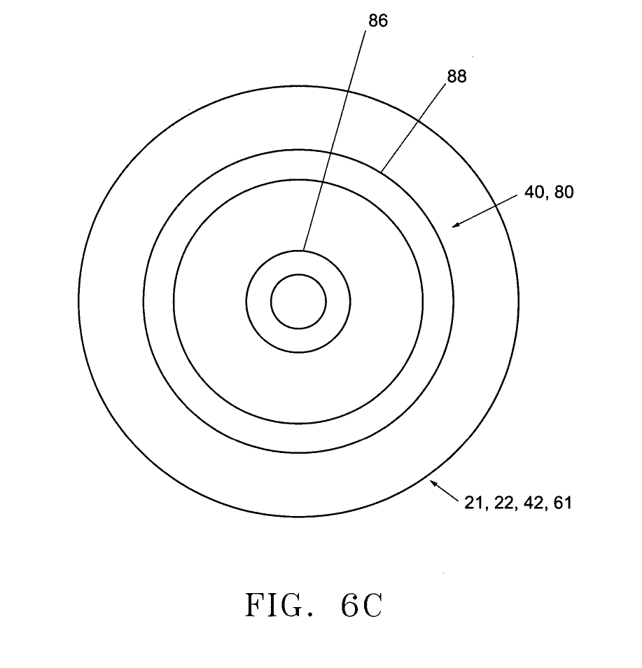

FIGS. 6A, 6B and 6C are cross-sectional views of substrate holder 21 and electrode assembly 22 of plasma reactor 10, electrode assembly 42 of plasma reactor 41 and substrate holder 61 of plasma reactor 50 showing the placement of the plasma control structure 40, 80, according to various embodiments of the invention. In the embodiment shown in FIG. 6A the plasma control structure 40, 80 comprises one ring structure 84. The ring structure 84 is shown substantially centered in the substrate holder 21, 61 and/or electrode assembly 22, 42. However, it must be appreciated that the ring 84 may have its center shifted relative to the center of substrate holder 21, electrode assembly 22, electrode assembly 42 or substrate holder 61. In the embodiment shown in FIG. 6B, the plasma control structure 40, 80 comprises one slug 82 and the ring structure 84. The slug 82 is positioned substantially at a center of substrate holder 21, electrode assembly 22, electrode assembly 42 or substrate holder 61. The ring structure 84 is positioned around the slug 82. In FIG. 6B, the ring structure 84 is shown centered around the slug 82. However, it must be appreciated that the ring structure 84 may be decentered, or its center shifted relative to a center of the slug 82. Furthermore, although the slug 82 and the ring structure are shown both centered in the substrate holder 21, 61 and electrode assembly 22, 42, it must be appreciated that any one of the slug 82 and the ring 84 may have its center shifted relative to the center of substrate holder 21, electrode assembly 22, electrode assembly 42 or substrate holder 61. In the embodiment shown in FIG. 6C, the plasma control structure 40, 80 comprises two ring structures 86 and 88. The ring structures 86 and 88 are radially spaced relative to each other. As shown in FIG. 6C, the ring structures 86 and 88 are centered relative to each other. However, it is contemplated that the ring structures 86 and 88 may be decentered relative to each other, i.e. their respective centers shifted relative to each other. In addition, it is further contemplated any of the ring structures 86 and 88 may be centered or decentered relative to a center of substrate holder 21, electrode assembly 22, electrode assembly 42 or substrate holder 61.

Similarly to the previous embodiments, the slug 82 in the plasma control structure 40, 80 may have any shape including a disk shape, i.e., with a circular cross-section, or any other cross-sectional shape, including a polygonal cross-section and an elliptical cross-section and/or may have a spherical, ellipsoid or a more complex shape. In addition, the ring structures 84, 86 and 88 may have plate-like structures (with a rectangular transversal cross-section) or toroid structures (with a polygonal transversal cross-section such as a hexagonal transversal cross-section, a circular transversal cross section or an elliptical transversal cross-section). Furthermore, although the plasma control structure is shown in FIG. 6B having one slug 82 and one ring structure 84 and shown in FIG. 6C having two ring structures 86 and 88, it must be appreciated any number of slugs and any number of ring structures may be used in combination. For example, the slug 82 in FIG. 6B may be replaced by the plurality of slugs 83 shown in FIG. 5A and 5B to form a plasma control structure having a plurality of slugs surrounded by a ring structure. Alternatively or in addition, one or more ring structures may be used to surround the one or more slugs 82, 83. Furthermore, a plurality of slugs may be disposed between spaced apart ring structures. For example, a plurality of azimuthally spaced apart slugs may be disposed in the space between the radially spaced apart ring structures 86 and 88. As a result, any number of slugs with same or different shapes and/or dimensions and any number of ring structures with same or different shapes and/or dimensions may be combined in a multitude of patterns so as to affect plasma characteristics as desired for a particular plasma process.

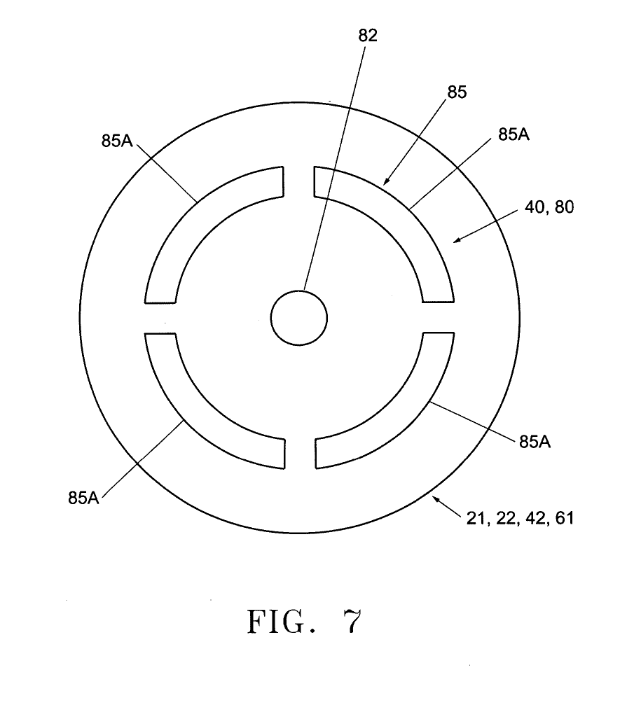

FIG. 7 is a cross-sectional view of substrate holder 21 and electrode assembly 22 of plasma reactor 10, electrode assembly 42 of plasma reactor 41 and substrate holder 61 of plasma reactor 50 showing the plasma control structure 40, 80, according to another embodiment of the invention. This embodiment is similar to the embodiment shown in FIG. 6B. However, in this embodiment, the plasma control structure 40, 80 comprises one slug 82 and a sector structure 85. The ring structure 84 in the embodiment of FIG. 6B is replaced by a sector structure 85. The sector structure 85 comprises four ring sectors 85A. The ring sectors 85A are azimuthally spaced apart. Although the sector structure 85 of the plasma control structure 40, 80 is shown having four ring sectors 85A, it must be appreciated any number of ring sectors may be used. Similarly to the embodiment shown in FIG. 6B, although the slug 82 and the sector structure 85 are shown both centered in the substrate holder 21, 61 and electrode assembly 22, 42, it must be appreciated that any one of the slug 82 and the sector structure 85 may have its center shifted relative to the center of substrate holder 21, electrode assembly 22, electrode assembly 42 or substrate holder 61. Furthermore, it must be appreciated that the slug 82 and the structure 85 may decentered relative to each other, i.e. a center of the sector structure 85 is shifted relative to a center of the slug 82. Of course any of the embodiments described previously may be combined with the embodiment depicted in FIG. 7. For example, instead of providing the plasma control structure 40, 80 with one sector structure 85 as shown herein, a plurality of sector structures 85 may be used.

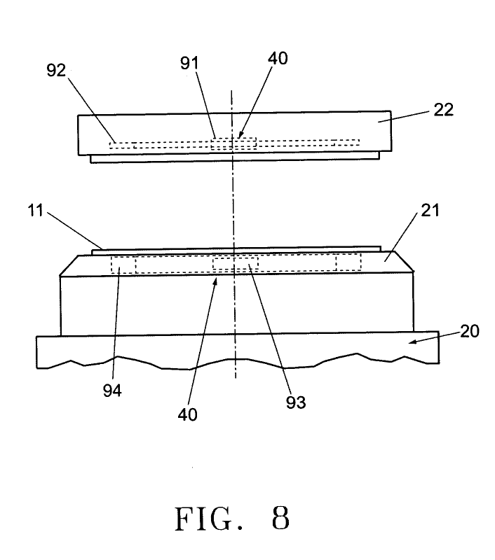

FIG. 8 is a transversal view of an electrode assembly and a chuck assembly showing a configuration of the plasma control structure 40 in plasma reactor 10, according to an embodiment of the present invention. In this embodiment, the plasma control structure 40 comprises slugs and ring structures disposed in the same configuration as the embodiment shown in FIG. 6B. In the present embodiment, the slugs and the ring structures of the plasma control structure 40 are selected with different thicknesses. For example, in the electrode assembly 22, the slug 91 is selected to be thicker than the ring structure 92. While, in the substrate holder 21, the slug 93 is selected to be thinner than the ring structure 94. The thickness of the slug and/or the ring structure can be tailored to improve plasma characteristics, for example, improve process uniformity.

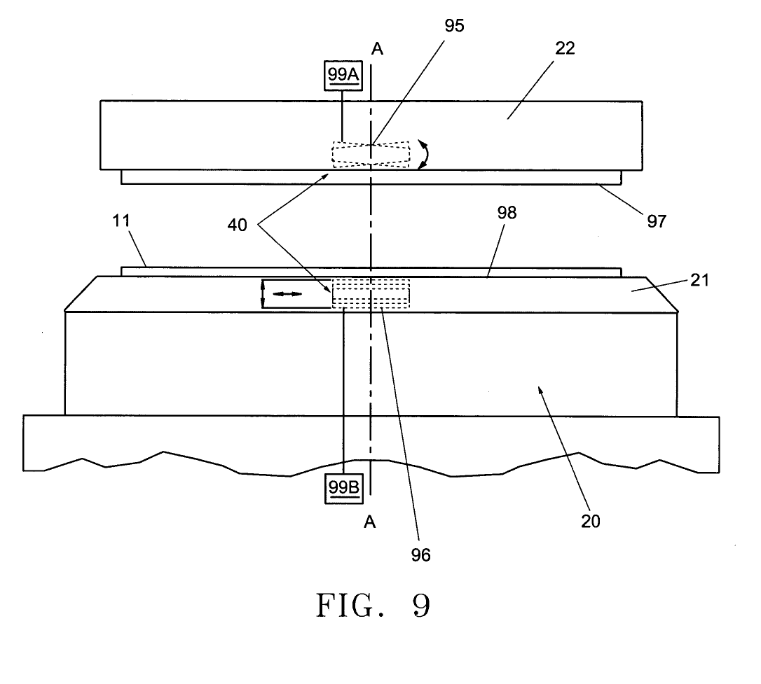

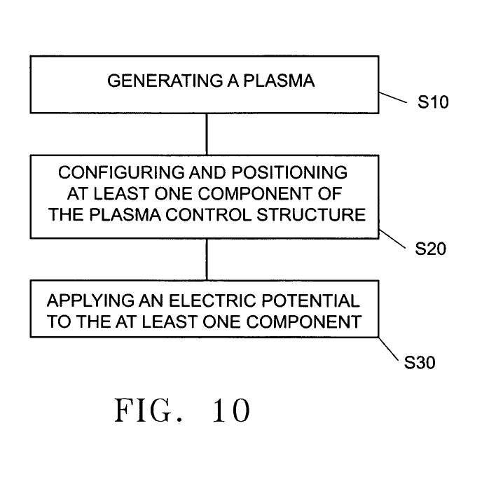

FIG. 9 is transversal view of an electrode assembly and a chuck assembly showing another configuration of the plasma control structure 40 in plasma reactor 10, according to another embodiment of the invention. In this embodiment, the plasma control assembly 40 comprises movable slugs 95 and 96. The slug 95 imbedded in electrode assembly 22 may be translated horizontally in a plane 97 of the electrode assembly 22, may be translated vertically in a direction substantially perpendicular to the plane 97, i.e. in the direction of the axis AA, and/or may be tilted at an angle relative to the plane 97. In FIG. 9, the slug 95 is depicted being tiltable relative to the plane of the electrode assembly, as shown by the double arrows. Similarly, the slug 96 imbedded in substrate holder 21 of chuck assembly 20 may also be translated horizontally in a plane 98 of the substrate holder, may be translated vertically in a direction substantially perpendicular to the plane, i.e., in the direction of the axis AA, and/or may also be tilted at an angle relative to the plane 98. In FIG. 9, the slug 96 is depicted being translated vertically. By providing a movable plasma control assembly 40, this allows to adjust the positioning of the plasma control assembly in the plasma reactor in order to achieve a better control of plasma process characteristics. Actuators 99A and 99B may be used to move the plasma control structure 40, i.e., to move the slug 95 and/or the slug 96. The actuators 99A and 99B can be one or more of fluid hydraulic actuators, pneumatic actuators, piezoelectric actuators, linear motors, or bladders, or any combination thereof. In an embodiment of the invention, actuators 99A and 99B comprise piezoelectric actuators, which when activated in a controlled fashion, translate and/or tilt the slug 95 and/or the slug 96.

Furthermore, although one slug (slug 96 in substrate holder 21 and slug 95 in electrode assembly 22) is illustrated herein being movable, it must be appreciated that any one of the slug(s) and/or ring(s) (including the ring sectors) of the plasma control assembly described in the previous embodiments can also be configured to be movable relative the electrode assembly and/or substrate holder. For example, the ring structure 84 and slug 82 depicted in FIG. 6B can be moved (horizontally, vertically and/or tilted) relative the electrode assembly 22, 42 and/or substrate holder 21, 61.

In addition, in an embodiment of the present invention, the slug(s) and/or ring(s) are located in cooling channels provided inside the chuck assembly and/or the electrode assembly. The cooling channels are provided in the chuck assembly and/or the electrode assembly so as to protect the chuck assembly and/or electrode assembly from heat damage due to the plasma. By using the cooling channels in the chuck assembly and/or electrode assembly, the slug(s) and/or ring(s) can be imbedded within the chuck assembly and/or electrode assembly.

The material of the various slug(s) and/or ring(s) (including the ring sectors) in the plasma control assembly can also be selected to achieve desired plasma process characteristics. For example, in an embodiment of the invention, the material of the various slug(s) and/or ring(s) may be selected to be different from of the material of the electrode assembly and/or different from the material of substrate holder in which the slug(s) and/or ring(s) are embedded. For example, the slug(s) and/or ring(s) can be formed of a dielectric material while the electrode assembly and/or substrate holder can be formed of an electrically conductive material. In this way, the RF field generated by the electrode assembly and/or the substrate holder and delivered to the plasma region can be altered and as a result the plasma characteristics can also be altered. In an embodiment of the invention, the dielectric material of the slug(s) and/or ring(s) comprises a dielectric fluid. In this case, cavities or canals with appropriate forms or shapes, formed in the substrate holder and/or the electrode assembly can be filled with the dielectric liquid so as to form the slug(s) and/or ring(s) of the plasma control assembly.

Furthermore, in an embodiment of the invention, any one of the various slug(s) and/or ring(s) described previously may comprise a magnetic material. In this case, the ring(s) and/or slug(s) having a magnetic material will generate a magnetic field in the vicinity of the plasma region or in the plasma region. The presence of the magnetic field can alter the plasma characteristics. Hence, by positioning the magnetic slug(s) and/or ring(s) in a certain configuration and/or selecting the magnetic properties of the magnetic material of the ring(s) and/or the slug(s), the plasma can be tailored to affect a uniformity of the plasma process.

In addition, in an embodiment of the invention, the slug(s) and/or ring(s) can be electrically biased by applying a selected voltage to one or more of the slug(s) and/or to one or more of the ring(s). In this case, the electrical voltage or electrical voltages applied to the one or more of the slug(s) and/or ring(s) will generate an electrical field around the plasma region and as a result it is possible to alter characteristics of the plasma to achieve desired effects on a substrate (e.g., wafer).

Moreover, it must be appreciated that the above embodiments can be also combined so as to generate an electromagnetic field in the plasma region. This allows increased control of the plasma characteristics. For example, one or more slugs and/or one or more rings may be connected to an electrical potential to generate an electric field in the vicinity of the plasma while one or more of the remaining slugs and/or one or more of the remaining rings can be provided with magnetic characteristics so as to generate a magnetic field in the vicinity of the plasma.

Moreover, when in use, an embodiment of the present invention provides a method of controlling a plasma in a vicinity of a substrate disposed on a chuck assembly in a plasma apparatus. The plasma apparatus includes a plasma control structure comprising at least one component imbedded in the chuck assembly, or in an electrode assembly in the plasma apparatus or both . The method includes generating a plasma in the plasma apparatus in the vicinity of the substrate, at step S10. The method also includes configuring and positioning the at least one component in the chuck assembly, in the electrode assembly, or both so as to alter characteristics of the plasma in the vicinity of the substrate, at step S20. In an embodiment of the invention, the configuring and the positioning of the at least one component includes moving the at least one component. In another embodiment, the method further includes applying an electric potential to the at least one component, at step S30.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments.

Moreover, the method and apparatus of the present invention, like related apparatus and methods used in the plasma arts are complex in nature, are often best practiced by empirically determining the appropriate values of the operating parameters, or by conducting computer simulations to arrive at best design for a given application. Accordingly, all suitable modifications and equivalents should be considered as falling within the spirit and scope of the invention.

In addition, it should be understood that the figures, are presented for example purposes only. The architecture of the present invention is sufficiently flexible and configurable, such that it may be utilized in ways other than that shown in the accompanying figures.

Furthermore, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

What is claimed is:

1. A plasma reactor, comprising:
a plasma processing chamber;
an electrode disposed inside the plasma processing chamber; and
a plasma control structure imbedded entirely within the electrode, the plasma control structure being configured and arranged to alter characteristics of a plasma generated inside the processing chamber.

2. The plasma reactor according to claim 1, wherein the plasma processing chamber is a vacuum chamber provided with an exhaust port.

3. The plasma reactor according to claim 1, further comprising a chuck assembly.

4. The plasma reactor according to claim 3, wherein the electrode is associated with the chuck assembly, the chuck assembly including a substrate holder constructed and arranged to hold a substrate disposed inside the chamber.

5. The plasma reactor according to claim 3, wherein the electrode is spaced apart from the chuck assembly.

6. The plasma reactor according to claim 1, further comprising a radio frequency power supply coupled to the electrode.

7. The plasma reactor according to claim 1, further comprising an induction coil wound around the chamber.

8. The plasma reactor according to claim 7, further comprising a radio frequency power supply coupled to the induction coil.

9. The plasma reactor according to claim 1, wherein the plasma control structure comprises a slug.

10. The plasma reactor according to claim 9, wherein the slug is positioned substantially at a center of the electrode.

11. The plasma reactor according to claim 9, wherein the slug is a disk-shaped object having a circular cross-sectional shape, an elliptical cross-sectional shape, or a polygonal cross-sectional shape or a combination thereof.

12. The plasma reactor according to claim 9, wherein the slug has a spherical shape, or an ellipsoid shape or a more complex shape.

13. The plasma reactor according to claim 9, wherein a shape of the slug is selected so as to achieve desired plasma uniformity in a vicinity of a substrate disposed inside the chamber.

14. The plasma reactor according to claim 9, wherein the slug is made from a material different from a material of the electrode.

15. The plasma reactor according to claim 9, wherein the slug comprises a dielectric material.

16. The plasma reactor according to claim 15, wherein the dielectric material in the slug includes a liquid dielectric material.

17. The plasma reactor according to claim 9, wherein the slug comprises a magnetic material.

18. The plasma reactor according to claim 9, wherein the slug is electrically biased by applying a selected voltage to the slug.

19. The plasma reactor according to claim 1, wherein the plasma control structure comprises a plurality of slugs.

20. The plasma reactor according to claim 19, wherein the plurality of slugs are arranged in the electrode so as to affect a uniformity of a plasma process in a vicinity of a substrate disposed inside the chamber.

21. The plasma reactor according to claim 19, wherein the plurality of slugs are disposed in cooling channels provided inside the electrode.

22. The plasma reactor according to claim 19, wherein the plurality of slugs have different shapes.

23. The plasma reactor according to claim 19, wherein at least one of the plurality of slugs has a material different from a material of the electrode.

24. The plasma reactor according to claim 19, wherein at least one of the plurality of slugs comprises a dielectric material.

25. The plasma reactor according to claim 24, wherein the dielectric material comprises a liquid dielectric.

26. The plasma reactor according to claim 19, wherein at least one of the plurality of slugs comprises a magnetic material.

27. The plasma reactor according to claim 19, wherein at least one of the plurality of slugs is electrically biased by applying a selected voltage to the at least one of the plurality of slugs.

28. The plasma reactor according to claim 1, wherein the plasma control structure comprises a ring structure.

29. The plasma reactor according to claim 28, wherein the ring structure has a rectangular transversal cross-section.

30. The plasma reactor according to claim 28, wherein the ring structure is a toroid structure having a circular transversal cross-section, an elliptical transversal cross-section, or a polygonal transversal cross-section, or a combination of two or more thereof.

31. The plasma reactor according to claim 28, wherein a shape of the ring structure is selected so as to achieve desired plasma uniformity in a vicinity of a substrate disposed inside the chamber.

32. The plasma reactor according to claim 28, wherein a material of the ring structure is different from a material of the electrode.

33. The plasma reactor according to claim 28, wherein the ring structure comprises a dielectric material.

34. The plasma reactor according to claim 33, wherein the dielectric material comprises a liquid dielectric.

35. The plasma reactor according to claim 28, wherein the ring structure comprises a magnetic material.

36. The plasma reactor according to claim 28, wherein the ring structure is electrically biased by applying a selected voltage to the ring structure.

37. The plasma reactor according to claim 1, wherein the plasma control structure comprises a plurality of ring structures.

38. The plasma reactor according to claim 37, wherein the plurality of ring structures are arranged in the electrode so as to affect a uniformity of a plasma process in a vicinity of a substrate disposed inside the chamber.

39. The plasma reactor according to claim 37, wherein the plurality of ring structures have different shapes.

40. The plasma reactor according to claim 37, wherein the plurality of ring structures are decentered from each other.

41. The plasma reactor according to claim 37, wherein at least one of the plurality of ring structures has its center shifted relative to a center of the electrode.

42. The plasma reactor according to claim 37, wherein a material of at least one of the plurality of ring structures is different from a material of the electrode.

43. The plasma reactor according to claim 37, wherein at least one of the plurality of ring structures comprises a dielectric material.

44. The plasma reactor according to claim 43, wherein the dielectric material comprises a liquid dielectric.

45. The plasma reactor according to claim 37, wherein at least one of the plurality of ring structures comprises a magnetic material.

46. The plasma reactor according to claim 37, wherein at least one of the plurality of ring structures is electrically biased by applying a selected voltage to the at least one of the plurality of ring structures.

47. The plasma reactor according to claim 1, wherein the plasma control structure comprises a slug and a ring structure.

48. The plasma reactor according to claim 47, wherein the slug and the ring structure are centered relative to each other.

49. The plasma reactor according to claim 47, wherein the slug and the ring structure are decentered relative to each other.

50. The plasma reactor according to claim 47, wherein a thickness of the slug and a thickness of the ring structure are selected so as to affect plasma uniformity in a vicinity of a substrate disposed inside the chamber.

51. The plasma reactor according to claim 50, wherein the thickness of the slug is different from the thickness of the ring structure.

52. The plasma reactor according to claim 47, wherein a material of the ring structure, or a material of the slug or both is different from a material of the electrode.

53. The plasma reactor according to claim 47, wherein a material of the ring structure, or a material of the slug or both comprises a dielectric material.

54. The plasma reactor according to claim 47, wherein the ring structure, the slug or both comprises a magnetic material.

55. The plasma reactor according to claim 47, wherein the ring structure, the slug or both is electrically biased by applying a selected voltage to the ring structure, the slug or both.

56. The plasma reactor according to claim 1, wherein the plasma control structure comprises a plurality of slugs and a ring structure, the ring structure surrounding the plurality of slugs.

57. The plasma reactor according to claim 1, wherein the plasma control structure comprises a plurality of slugs and a plurality of ring structures, and at least a portion of the plurality of slugs is disposed between two spaced apart ring structures in the plurality of ring structures.

58. The plasma reactor according to claim 1, wherein the plasma control structure comprises a slug and a sector structure.

59. The plasma reactor according to claim 58, wherein the sector structure comprises a plurality of ring sectors.

60. The plasma reactor according to claim 58, wherein any one of the slug and the plurality of ring sectors is movable relative to the substrate holder.

61. The plasma reactor according to claim 58, wherein a material of at least one of the plurality of ring sectors is different from a material of the electrode.

62. The plasma reactor according to claim 58, wherein at least one of the plurality of ring sectors comprises a magnetic material.

63. The plasma reactor according to claim 58, wherein at least one of the plurality of ring sectors is electrically biased by applying a selected voltage to the at least one of the plurality of ring sectors.

64. The plasma reactor according to claim 1, wherein the plasma control structure is movable relative to the electrode.

65. The plasma reactor according to claim 1, wherein the plasma control structure is translatable horizontally in a plane of the electrode, translatable vertically in a direction perpendicular to the plane of the electrode, tiltable relative the plane of the electrode, or any combination thereof.

66. A method of controlling a plasma in a vicinity of a substrate disposed on a chuck assembly in a plasma apparatus, the plasma apparatus including a plasma control structure comprising at least one component imbedded in the chuck assembly, or in an electrode assembly in the plasma apparatus or both, the method comprising:
generating a plasma in the plasma apparatus in the vicinity of the substrate;
configuring and positioning the at least one component in the chuck assembly, the electrode assembly or both so as to alter characteristics of the plasma in the vicinity of the substrate.

67. The method according to claim 66, wherein configuring and positioning the at least one component includes moving the at least one component.

68. The method according to claim 66, further comprising applying an electric potential to the at least one component.
